(19) United States
(12) Patent Application Publication
(10) Pub. No.: US 2025/0103927 A1
(43) Pub. Date: Mar. 27, 2025

(54) OUTLIER REMOVAL METHOD AND OUTLIER REMOVAL DEVICE

(71) Applicant: Proterial, Ltd., Tokyo (JP)

(72) Inventors: Takehiko TANI, Tokyo (JP); Tomonori WATANABE, Tokyo (JP)

(21) Appl. No.: 18/888,378

(22) Filed: Sep. 18, 2024

(30) Foreign Application Priority Data
Sep. 26, 2023 (JP) 2023-163745

(51) Int. Cl. G06N 7/00

(52) U.S. Cl. CPC G06N 7/00

(57) ABSTRACT

An outlier removal method for removing an outlier included in training data including data of an explanatory variable and an objective variable used for machine learning is provided with an evaluation metrics calculation step comprising a model creation step of dividing the training data into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times; an outlier determination step of determining an outlier by determining whether each data included in the training data is an outlier based on a calculation result of the evaluation metrics calculation step by using both the first evaluation metric and the second evaluation metric as metrics when the each data is used as the test data; and an outlier removal step of removing data determined to be an outlier in the outlier determination step.

### CROSS-REFERENCE TO RELATED APPLICATIONS

The present patent application claims the priority of Japanese patent application No. 2023-163745 filed on Sep. 26, 2023, the entire contents of which are incorporated herein by reference.

### TECHNICAL FIELD

The present disclosure relates to an outlier removal method and an outlier removal device.

### BACKGROUND OF THE INVENTION

Methods for making various predictions using machine learning are known. For example, in case of predicting the physical properties of a material with unknown mixing proportion, machine learning is performed using data already obtained through trial manufacturing, etc., as training data (teacher data, supervised data) to learn the correlation between the mixing proportions of the materials and the physical properties, and prediction is made using a regression model obtained as a result of the learning.

Prior art document information related to the invention of the present disclosure includes Patent Literature 1.

### Citation List Patent Literature 1: JP2020-30738A

### SUMMARY OF THE INVENTION

However, if training data contains erroneous data or outliers, which are data with large errors, the prediction accuracy of the regression model obtained using such training data decreases. Therefore, it is desirable to remove outliers from the training data prior to machine learning. However, it is difficult to determine which data are outliers properly. Particularly when the training data is sparse data, it is difficult to remove outliers properly.

Therefore, the object of the invention is to provide an outlier removal method and an outlier removal device that can properly remove outliers.

To solve the problems described above, one aspect of the present invention provides an outlier removal method for removing an outlier included in training data that comprises data of an explanatory variable and an objective variable used for machine learning, the method comprising:
an evaluation metrics calculation step comprising a model creation step of dividing the training data into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times; an outlier determination step of determining an outlier by determining whether each data included in the training data is an outlier based on a calculation result of the evaluation metrics calculation step by using both the first evaluation metric and the second evaluation metric as metrics when the each data is used as the test data; and an outlier removal step of removing data determined to be an outlier in the outlier determination step.

To solve the problems described above, another aspect of the present invention provides an outlier removal device that removes an outlier included in training data that comprises data of an explanatory variable and an objective variable used for machine learning, the device comprising:
an evaluation metrics calculation processing unit for performing a model creation step of dividing the training data into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times;
an outlier determination processing unit for determining an outlier by determining whether each data included in the training data is an outlier based on a calculation result of the evaluation metrics calculation step by using both the first evaluation metric and the second evaluation metric as metrics when the each data is used as the test data; and an outlier removal processing unit for removing data determined to be an outlier in the outlier determination processing unit.

### Advantageous Effects of the Invention

According to the invention, it is possible to provide an outlier removal method and an outlier removal device that can properly remove outliers.

### BRIEF DESCRIPTION OF DRAWINGS

FIG. 1 is a schematic configuration diagram illustrating an outlier removal device in an embodiment.

FIG. 2 is a diagram illustrating an example of training data.

FIG. 3A is an explanatory diagram illustrating evaluation metrics calculation processing.

FIG. 3B is an explanatory diagram illustrating an example of ranking data.

FIG. 4 is a flowchart showing an outlier removal method in the embodiment of the invention.

FIG. 5 is a flowchart showing the evaluation metrics calculation processing.

FIG. 6 is a flowchart showing outlier calculation processing.

FIG. 7 is a flowchart showing outlier removal processing.

FIG. 8 is a graph showing the change in the average value of second evaluation metrics (determination coefficient) when outlier removal is performed.

### DETAILED DESCRIPTION OF THE INVENTION

### Embodiment

An embodiment of the invention will be described below in conjunction with the appended drawings.

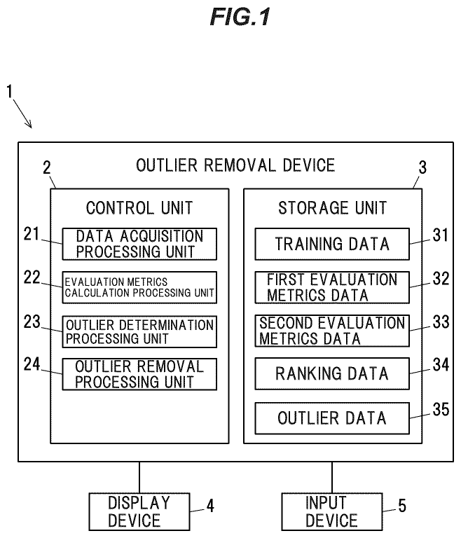

FIG. 1 is a schematic configuration diagram illustrating an outlier removal device 1 in the present embodiment. The outlier removal device 1 is a device that removes outliers included in training data 31 which is used for machine learning. The outlier means a value that deviates significantly from other data due to, e.g., a measurement error, human error such as misreading the instrument or input mistake, or influence of noise, etc. Detecting and removing outliers from the training data 31 is expected to improve prediction accuracy when machine learning is performed using the training data 31.

The outlier removal device 1 has a control unit 2 and a storage unit 3. The outlier removal device 1 is, e.g., a computer such as personal computer or server device, and includes an arithmetic element such as a CPU, a memory such as RAM or ROM, a storage device such as hard disk, and a communication interface that is a communication device such as LAN card.

The control unit 2 has a data acquisition processing unit 21, an evaluation metrics calculation processing unit 22, an outlier determination processing unit 23 and an outlier removal processing unit 24. Details of each unit will be described later. The storage unit 3 is realized by a predetermined storage area of a memory or storage device.

The outlier removal device 1 also has a display device 4 and an input device 5. The display device 4 is, e.g., a liquid crystal display, and the input device 5 is, e.g., a keyboard and a mouse, etc. The display device 4 may be configured as a touch panel, and the display device 4 may also serve as the input device 5. In addition, the display device 4 and the input device 5 may be configured separately from the outlier removal device 1 and be capable of communicating with the outlier removal device 1 by wireless communication, etc. In this case, the display device 4 or input device 5 may be composed of a portable terminal such as a tablet or smartphone.

### Data Acquisition Processing Unit 21

The data acquisition processing unit 21 performs data acquisition processing to acquire the training data 31 from an external device. In the data acquisition processing, for example, the training data 31 is acquired through a network from a prediction device, etc. which uses the training data 31. However, the training data 31 may be, e.g., input to the outlier removal device 1 via a medium such as USB memory, and the method for acquiring the training data 31 is not particularly limited.

### Training Data 31

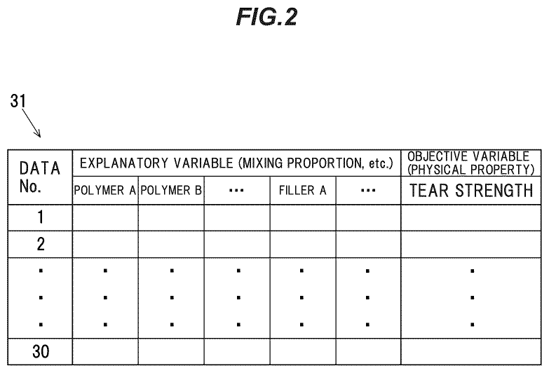

Here, the training data 31 will be described. FIG. 2 is a diagram illustrating an example of the training data 31. The training data 31 is a database used as teacher data when performing machine learning, and includes data of explanatory and objective variables used in machine learning. FIG. 2 shows an example in which the mixing amounts of materials such as polymers and fillers, etc., are used as explanatory variables, and the physical property (tear strength in this example) of a composite material produced using said materials is used as an objective variable. Performing machine learning using this training data 31 and creating a regression model representing a correlation between the explanatory variable (the mixing amount of each material) and the objective variable (the physical property) allows for prediction of the physical property of a composite material when manufactured with unknown mixing proportions of materials. Here, the case where the training data 31 contains thirty pieces of data in the initial state will be explained.

### Evaluation Metrics Calculation Processing Unit 22

The evaluation metrics calculation processing unit 22 performs evaluation metrics calculation processing in which three steps, i.e., a model creation step, a first evaluation metrics calculation step, and a second evaluation metrics calculation step are repeated a predetermined number of times. The evaluation metrics calculation processing corresponds to the evaluation metrics calculation step in the invention.

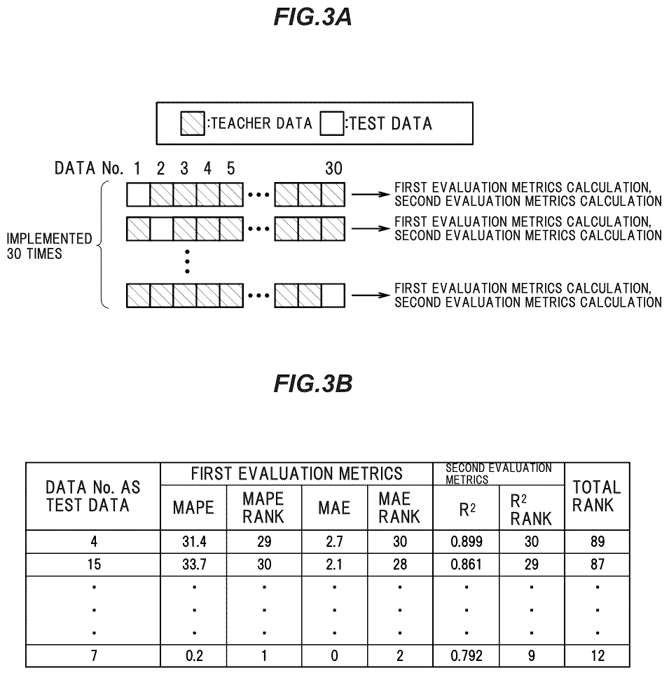

In the model creation step, the training data 31 is divided into teacher data and test data, and a regression model (learned model) showing the correlation between explanatory variables and objective variables is created using the teacher data. As shown in FIG. 3A, first, the evaluation metrics calculation processing unit 22 randomly divides the training data 31 into teacher data and test data. In the present embodiment, the division is made so that only one data in the training data 31 (thirty pieces of data) is used as test data, and the remaining data is used as teacher data (twenty-nine pieces of data). After data division, machine learning is performed using the teacher data, and as a result of this machine learning, a regression model representing the correlation between the explanatory variable and the objective variable is created.

In the first evaluation metrics calculation step, an evaluation metric is calculated using test data for the regression model created in the model creation step and is used as the first evaluation metric. More precisely, in the first evaluation metrics calculation step, test data (one piece of data in this case) is applied to the regression model created in the model creation step to obtain the predicted value of the objective variable, and the first evaluation metric representing the coincidence degree (prediction accuracy) or prediction error between the predicted value and the measured value (value of the objective variable in the test data) is obtained. The obtained first evaluation metric is stored in the storage unit 3 as the first evaluation metrics data 32.

In the second evaluation metrics calculation step, an evaluation metric is calculated using the teacher data (here, twenty-nine pieces of data) for the regression model created in the model creation step, and is used as the second evaluation metric. In more detail, the second evaluation metrics calculation step applies the teacher data to each of the regression models created in the model creation step to obtain the predicted values of the objective variables (here, twenty-nine), and also obtains the second evaluation metric representing the coincidence degree (prediction accuracy) or prediction error between the predicted values and the measured values (values of the objective variables in the teacher data). The obtained second evaluation metric is stored in the storage unit 3 as the second evaluation metrics data 33.

As the first and second evaluation metrics, metrics indicating prediction accuracy such as the determination coefficient R2 or metrics indicating prediction error can be used. When the prediction error is used as the first or second evaluation metrics, mean error (ME), mean absolute error (MAE), root mean square error (RMSE), mean percent error (MPE), mean absolute error rate (MAPE), root mean square error rate (RMSPE), etc. can be used as the prediction error. More preferably, at least one of ME, MAE, and RMSE, and one of MPE, MAPE, and RMSPE is used as the prediction error. This is because when only MAE, ME, or RMSE is used, there is sufficient margin when the value of the objective variable (here, tear strength) is small, but when the value of the objective variable (here, tear strength) is large, the determination becomes more stringent and there is a risk of judging data that are not outliers as outliers. In addition, when only MAPE, MPE, or RMSPE is used, there is sufficient margin when the value of the objective variable (here, tear strength) is large, but when the value of the objective variable (here, tear strength) is small, determination becomes more stringent, and there is a risk that data that is not an outlier will be judged as an outlier. In the present embodiment, MAE and MAPE were used as the first evaluation metrics. In addition, the determination coefficient R2 was used as the second evaluation metrics. When MAE and MAPE, etc. are used as the second evaluation metrics, the same number of MAE and MAPE, etc. as the teacher data will be obtained, so the average or median value is preferably used as the representative value for the second evaluation metrics.

The evaluation metrics calculation processing unit 22 repeats the three steps of the model creation step, the first evaluation metrics calculation step, and the second evaluation metrics calculation step for a preset number of times. In the present embodiment, the number of repetitions is the same as the number of data included in the training data 31 (thirty times in this case) because the number of data to be divided as test data is set as one. In addition, all data included in the training data 31 must be selected as test data once.

### Outlier Determination Processing Unit 23

The outlier determination processing unit 23 performs outlier determination processing based on the calculation results (the first evaluation metrics data 32 and the second evaluation metrics data 33) of the evaluation metrics calculation processing unit 22, using both the first and second evaluation metrics for each of the data included in the training data 31 as metrics when said data is used as test data. The outlier determination process is performed to determine whether the data is an outlier.

In the present embodiment, the outlier determination processing unit 23 ranks the first evaluation metrics and the second evaluation metrics, and calculates the metrics value when each data is used as test data based on both of those rankings. Here, the total rank, which is the sum of the ranks of the first and second evaluation metrics, was used as the metrics value. The obtained ranks and total ranks are stored in storage unit 3 as ranking data 34.

FIG. 3B shows an example of the ranking data 34. As shown in FIG. 3B, the ranking data 34 includes the ranking of the first and second evaluation metrics when each data is used as test data and the total rank, which is the metric value. The MAE and MAPE used as the first evaluation metrics are ranked so that the higher the value, the lower the rank (the higher the ranking number). This means that the higher the ranking number, the greater the likelihood that the test data is an outlier. The determination coefficient R2 used as the second evaluation metric is also ranked so that the larger the value, the lower the rank (the larger the ranking number). A higher value for the determination coefficient R2 means a higher prediction accuracy, and a higher prediction accuracy with only the teacher data excluding the test data means a greater likelihood that the test data is an outlier.

Thus, in the present embodiment, for both the first and second evaluation metrics, the higher the ranking number, the greater the likelihood that the test data is an outlier. Therefore, the total rank that is the sum of these ranks is used as the metrics value for determining outliers. By using MAE, MAPE, etc. as the first evaluation metrics and the determination coefficient R2 as the second evaluation metrics, the same algorithm can be used to process the ranking (so that the higher the value, the larger the ranking number), thereby simplifying the process.

Then, the outlier determination processing unit 23 sums the ranks of the first evaluation metric, MAE, and MAPE, and the rank of the second evaluation metric, the determination coefficient R2, to obtain the total rank. Note that here, both the rank of MAE and the rank of MAPE are added together when determining the total rank, and the weighting is such that the influence of the first evaluation metrics is greater than that of the second evaluation metrics. However, it is not limited to this, for example, the rank of the first evaluation metrics may be obtained by averaging the rank of MAE and the rank of MAPE, and then adding this rank and the rank of the second evaluation metrics to obtain the total rank. In this way, the method of obtaining the total rank, which is a metrics value, can be changed as needed, and weighting and other adjustments may be made considering the trend of the training data 31 to be used.

The outlier determination processing unit 23 also determines whether the predetermined end condition is met. When the end condition is satisfied, the outlier determination processing unit 23 determines that there are no outliers in the training data 31 and terminates the process. When the end condition is not satisfied, the outlier determination processing unit 23 determines the data with the highest total rank value as the metrics value (data number 4 in the example shown in FIG. 3B), to be an outlier.

The end condition can be set as appropriate. For example, when the average value of the determination coefficient R2 used as the second evaluation metric is saturated, it may be determined that the end condition is satisfied. Whether or not the average value of the determination coefficient R2 is saturated can be determined, for example, based on the amount of variation in the average value of the determination coefficient R2 (the difference in values before and after removing outliers when outliers are removed). Not limited to this, for example, the end condition can be determined to have been satisfied when the average or median value of the determination coefficient R2 becomes equal to or greater than a preset threshold value. The end condition may be any condition under which it can be determined that the prediction accuracy is sufficiently high, and can be set as appropriate.

### Outlier Removal Processing Unit 24

The outlier removal processing unit 24 performs outlier removal processing to remove data determined to be an outlier in the outlier determination processing. The outlier removal processing corresponds to an outlier removal step in the invention.

The outlier removal processing unit 24 is configured to remove only one data when there are plural data determined to be outliers in the outlier determination processing. This is because some of data determined to be outliers may have a low prediction accuracy (i.e., large prediction error) due to the influence of other outliers, and it is to prevent data which are not outliers from being removed.

The outlier removal processing unit 24 removes only one data determined as an outlier in the outlier determination processing from the training data 31 and updates the training data 31. The outlier removal processing unit 24 stores the data removed as the outlier as an outlier data 35 in the storage unit 3.

### Outlier Removal Method

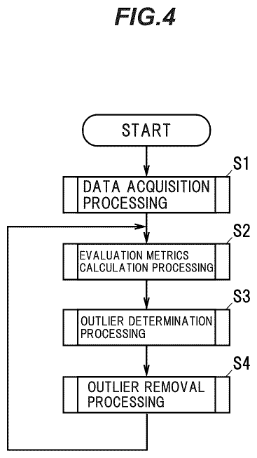

FIG. 4 is a flowchart showing an outlier removal method in the present embodiment. As shown in FIG. 4, first, the data acquisition processing unit 21 performs the data acquisition processing to acquire the training data 31 from an external device, etc. in step S1. The acquired training data 31 is stored in the storage unit 3.

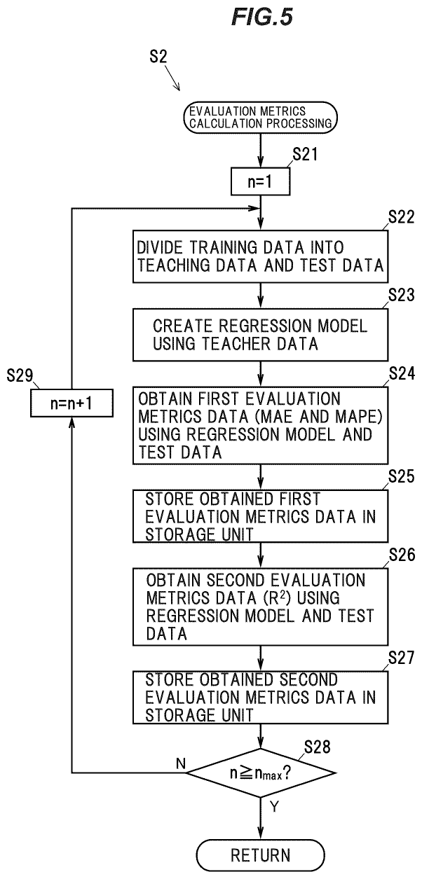

Then, in step S2, the evaluation metrics calculation processing is performed. In the evaluation metrics calculation processing, as shown in FIG. 5, first, in step S21, a variable n representing the number of repetitions is assigned the initial value 1. Also, a variable nₘₐₓ representing the maximum number of repetitions is assigned a numerical value (here, 30). Then, in step S22, the evaluation metrics calculation processing unit 22 divides the training data 31 into teacher data and test data. In this case, for example, the nth data is the test data, and the other data is the teacher data. Then, in step S23, the evaluation metrics calculation processing unit 22 creates a regression model using the teacher data. Then, in step S24, the evaluation metrics calculation processing unit 22 applies the test data to the created regression model to obtain the first evaluation metrics, MAE and MAPE. Then, in step S25, the evaluation metrics calculation processing unit 22 stores the obtained MAE and MAPE as the first evaluation metrics data 32 in the storage unit 3. Then, in step S26, the evaluation metrics calculation processing unit 22 applies the teacher data to the created regression model to obtain the determination coefficient R2, which is the second evaluation metric. Then, in step S27, the evaluation metrics calculation processing unit 22 stores the obtained determination coefficient R2 in the storage unit 3 as the second evaluation metrics data 33. Then, in step S28, it is determined whether the variable n is greater than or equal to nₘₐₓ (here, 30). If NO (N) is determined in step S28, n is incremented in step S29 before returning to step S22. If YES (Y) is determined in step S28, return and go to step S3 in FIG. 4.

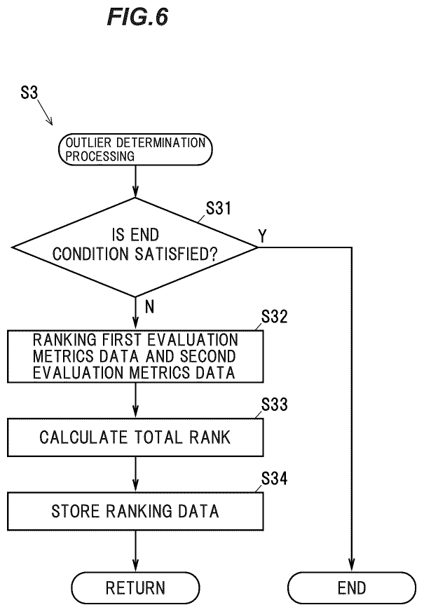

In step S3, the outlier determination processing is performed. In the outlier determination processing, as shown in FIG. 6, first, in step S31, the outlier determination processing unit 23 determines whether the predetermined end condition is satisfied. If it is determined to be yes (Y) in step S31, the process is terminated. If it is determined to be No (N) in step S31, in step S32, the first and second evaluation metrics are ranked, and in step S33, the total rank is obtained when each data is used as test data. Then, in step S34, the rank obtained in step S32 and the total rank obtained in step S33 are stored in memory section 3 as the ranking data 34. After that, it returns and proceeds to step S4 in FIG. 4.

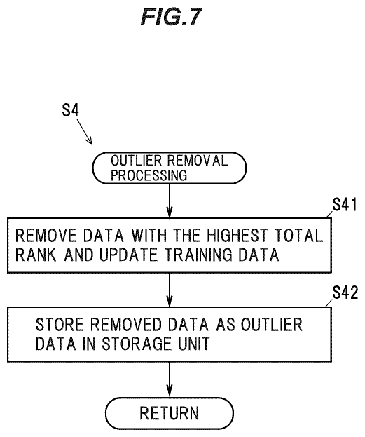

In step S4, the outlier removal processing is performed. In the outlier removal processing, as shown in FIG. 7, first, in step S41, the outlier removal processing unit 24 updates the training data 31 by removing the data with the largest total rank, and in step S42, the removed data is stored in the storage unit 3 as the outlier data 35. Then, it returns and proceeds to step S2 in FIG. 4.

### Change in Prediction Accuracy by Removing Outliers

The change in prediction accuracy when outliers are removed using this method of outlier removal was examined. Thirty pieces of data were used as the training data 31, and mixing proportion of five different materials and material information that quantified the characteristics of the material composition (e.g., filler volume fraction) of the five differential materials as explanatory variables, and tear strength as an objective variable.

The data division (partitioning) of the training data 31, the creation of a regression model using the teacher data obtained by division, and the measurement of the first evaluation metrics (MAE and MAPE) by applying the test data obtained by division to the regression model and the second evaluation metric (determination coefficient R2) by applying the teacher data to the regression model were repeated as many times as the number of data (more specifically, thirty times for the first time and twenty-nine times after removing one outlier), and the first and second evaluation metrics were obtained for each data when the said data were used as test data. Then, the first and second evaluation metrics for each data were ranked, and the total rank was obtained. The data with the highest total rank was then repeated for removal.

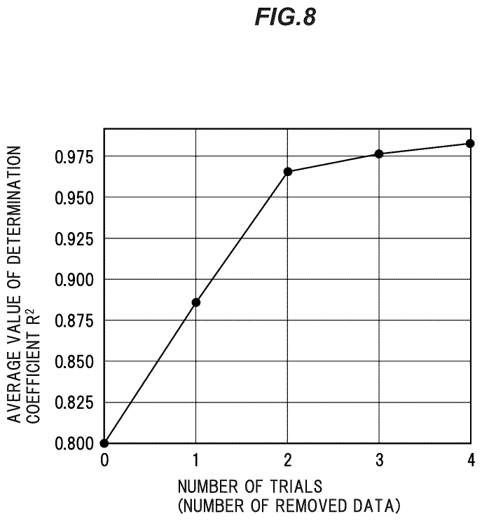

The change in the average value of the second evaluation metric, the determination coefficient R2, is shown in FIG. 8. As shown in FIG. 8, the more data is removed as outliers, the higher the average value of the determination coefficient R2 becomes, indicating that the prediction accuracy has improved. In other words, it can be seen that the outlier removal method in the present embodiment could remove outliers appropriately. In addition, as the number of trials (the number of data removed as outliers) increases, the average value of the determination coefficient R2 is saturated. Therefore, it was also confirmed that the average value of the determination coefficient R2 is saturated or not, which is the end condition to terminate the outlier removal processing.

### Functions and Effects of the Embodiment

As explained above, the outlier removal method in the present embodiment is a method for removing an outlier included in training data 31 that comprises data of an explanatory variable and an objective variable used for machine learning, the method comprising: an evaluation metrics calculation step comprising a model creation step of dividing the training data 31 into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times;
an outlier determination step of determining an outlier by determining whether each data included in the training data 31 is an outlier based on a calculation result of the evaluation metrics calculation step by using both the first evaluation metric and the second evaluation metric as metrics when the each data is used as the test data; and an outlier removal step of removing data determined to be an outlier in the outlier determination step.

This makes it possible to appropriately remove outliers when outliers are included in the training data 31, taking into account the prediction accuracy of both test data and teacher data. As a result, it becomes possible to use the training data 31 with appropriately removed outliers for machine learning, and to improve the prediction accuracy of physical property prediction, etc. In addition to the existence of outliers, there are many other causes of low prediction accuracy (large prediction errors), such as overlearning, insufficient learning, and regression model malfunctions due to inappropriate hyperparameter values, etc. For example, if only test data is considered (using only the first evaluation metrics as the metrics), there is a risk that these causes may result in removing the value as an outlier even though it is not an outlier. In the present embodiment, outliers are determined by also considering the teacher data (also considering the second evaluation metrics), and this makes it possible to suppress the influence of the other causes mentioned above and remove outliers appropriately.

### Modification

Although not mentioned in the above embodiment, the outlier removal device 1 may be incorporated as a function in a prediction device that makes predictions of physical properties, etc. using the training data 31. In this case, the prediction device would be equipped with a regression model creation unit that performs machine learning using the outlier-removed training data 31 to create a regression model indicating the correlation between explanatory variables and objective variables, and a prediction unit that predicts physical properties, etc. using the regression model created by the regression model creation unit.

In the above embodiment, only one test data is used in the evaluation metrics calculation step at the time of data division, but multiple test data may be used. In this case, the number of repetitions of the evaluation metrics calculation step may be set to a large number so that multiple first and second evaluation metrics are obtained when any data is used as test data, the average and median value of the multiple first and second evaluation metrics when any data is used as test data are used as metrics, and the outlier determination is performed based on the results of the ranking. However, in this case, the calculation load becomes large and the calculation takes time, so it is more desirable to use only one test data to make the processing simpler.

### Summary of Embodiment

Next, the technical concepts that can be grasped from the above embodiment will be described with the help of the codes, etc. in the embodiment. However, each sign, etc. in the following description is not limited to the members, etc. specifically shown in the embodiment for the constituent elements in the scope of claims.

According to the first feature, an outlier removal method is a method for removing an outlier included in training data 31 that comprises data of an explanatory variable and an objective variable used for machine learning, the method including: an evaluation metrics calculation step including a model creation step of dividing the training data 31 into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times;
an outlier determination step of determining an outlier by determining whether each data included in the training data 31 is an outlier based on a calculation result of the evaluation metrics calculation step by using both the first evaluation metric and the second evaluation metric as metrics when the each data is used as the test data; and an outlier removal step of removing data determined to be an outlier in the outlier determination step.

According to the second feature, in the outlier removal method as described in the first feature, the outlier determination step includes ranking the first evaluation metric and ranking the second evaluation metric, respectively, calculating a metric value based on both ranks using an arbitrary data as the test data, and determining whether the arbitrary data is an outlier based on the obtained metric value.

According to the third feature, in the outlier removal method as described in the first or second feature, in the evaluation metrics calculation step, the division is performed in such a manner that only one data in the training data 31 is used as the test data and a remaining data is used as the teacher data.

According to the fourth feature, in the outlier removal method as described in the any one of the first to third features, a prediction error is used in at least one of the first evaluation metrics and the second evaluation metrics, and at least one of mean error (ME), mean absolute error (MAE) and root mean square error (RMSE) and one of mean percentage error (MPE), mean absolute percentage error (MAPE) and root mean square percentage error (RMSPE) are used as the prediction error.

According to the fifth feature, in the outlier removal method as described in the fourth feature, the prediction error is used as the first evaluation metric and a determination coefficient is used as the second evaluation metric.

According to the sixth feature, an outlier removal device 1 that removes an outlier included in training data 31 that comprises data of an explanatory variable and an objective variable used for machine learning, the device including: an evaluation metrics calculation processing unit 22 for performing a model creation step of dividing the training data 31 into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times;
an outlier determination processing unit 23 for determining an outlier by determining whether each data included in the training data 31 is an outlier based on a calculation result of the evaluation metrics calculation step by using both the first evaluation metric and the second evaluation metric as metrics when the each data is used as the test data; and
an outlier removal processing unit 24 for removing data determined to be an outlier in the outlier determination processing unit 23.

### APPENDIX

The above description of the embodiment of the invention does not limit the invention as claimed above. It should also be noted that not all of the combinations of features described in the embodiment are essential to the means for solving the problems of the invention. In addition, the invention can be implemented with appropriate modifications to the extent that it does not depart from the gist of the invention.

1. An outlier removal method for removing an outlier included in training data that comprises data of an explanatory variable and an objective variable used for machine learning, the method comprising:
an evaluation metrics calculation step comprising a model creation step of dividing the training data into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times;
an outlier determination step of determining an outlier by determining whether each data included in the training data is an outlier based on a calculation result of the evaluation metrics calculation step by using both the first evaluation metric and the second evaluation metric as metrics when the each data is used as the test data; and
an outlier removal step of removing data determined to be an outlier in the outlier determination step.

2. The outlier removal method, according to claim 1, wherein the outlier determination step includes ranking the first evaluation metric and ranking the second evaluation metric, respectively, calculating a metric value based on both ranks using an arbitrary data as the test data, and determining whether the arbitrary data is an outlier based on the obtained metric value.

3. The outlier removal method, according to claim 1, wherein, in the evaluation metrics calculation step, the division is performed in such a manner that only one data in the training data is used as the test data and a remaining data is used as the teacher data.

4. The outlier removal method, according to claim 1, wherein a prediction error is used in at least one of the first evaluation metrics and the second evaluation metrics, and at least one of mean error (ME), mean absolute error (MAE) and root mean square error (RMSE) and one of mean percentage error (MPE), mean absolute percentage error (MAPE) and root mean square percentage error (RMSPE) are used as the prediction error.

5. The outlier removal method, according to claim 4, wherein the prediction error is used as the first evaluation metric and a determination coefficient is used as the second evaluation metric.

6. An outlier removal device that removes an outlier included in training data that comprises data of an explanatory variable and an objective variable used for machine learning, the device comprising:
an evaluation metrics calculation processing unit for performing a model creation step of dividing the training data into teacher data and test data and creating a regression model representing a correlation between the explanatory variable and the objective variable using the teacher data, a first evaluation metrics calculation step of calculating an evaluation metric using the test data on the created regression model to provide a first evaluation metric, and a second evaluation metrics calculation step of calculating an evaluation metric using the teacher data on the created regression model to provide a second evaluation metric, and repeating the model creation step, the first evaluation metrics calculation step, and the second evaluation metrics calculation step for a predetermined number of times;
an outlier determination processing unit for determining an outlier by determining whether each data included in the training data is an outlier based on a calculation result of the evaluation metrics calculation step by using both the first evaluation metric and the second evaluation metric as metrics when the each data is used as the test data; and
an outlier removal processing unit for removing data determined to be an outlier in the outlier determination processing unit.
